(19) United States
(12) Patent Application Publication
(10) Pub. No.: US 2026/0142546 A1
(43) Pub. Date: May 21, 2026

(54) OPERATING FREQUENCY ADJUSTMENT FOR MISMATCHED POWER SUPPLY CIRCUITS

(71) Applicant: QUALCOMM Incorporated, San Diego, CA (US)

(72) Inventors: Guoyong GUO, San Jose, CA (US); Joseph Dale RUTKOWSKI, Chandler, AZ (US)

(21) Appl. No.: 18/952,502

(22) Filed: Nov. 19, 2024

(51) Int. Cl. H02M 1/00; H02M 3/158

(52) U.S. Cl. CPC H02M 1/0003; H02M 3/158

(57) ABSTRACT

Techniques and apparatus for supplying power, including operating frequency adjustment for mismatched power supply circuits. One example power supply circuit generally includes a common output node, a first switched-mode power supply (SMPS) circuit including an output coupled to the common output node, one or more first sensors, a second SMPS circuit including an output coupled to the common output node, one or more second sensors, and a control circuit. The control circuit is generally configured to (i) receive, from the one or more first sensors, a first indication of a first current or a first temperature associated with the first SMPS circuit, (ii) receive, from the one or more second sensors, a second indication of a second current or a second temperature associated with the second SMPS circuit, and (iii) control, based on the first indication and the second indication, adjustment of an operating frequency of the first SMPS circuit.

### TECHNICAL FIELD

Certain aspects of the present disclosure generally relate to power supply circuits and, more particularly, to power supply circuits with operating frequency control to adjust for mismatches therebetween.

### BACKGROUND

A voltage regulator ideally provides a constant direct current (DC) output voltage regardless of changes in load current or input voltage. Voltage regulators may be classified as linear regulators or switching regulators. While linear regulators tend to be relatively compact, many applications may benefit from the increased efficiency of a switching regulator. A linear regulator may be implemented by a low-dropout (LDO) regulator, for example. A switching regulator (also known as a “switching converter” or “switcher”) may be implemented, for example, by a switched-mode power supply (SMPS), such as a buck converter, a boost converter, a buck-boost converter, or a charge pump.

For example, a buck converter is a type of SMPS typically comprising: (1) a high-side switch coupled between a relatively higher voltage rail and a switching node, (2) a low-side switch coupled between the switching node and a relatively lower voltage rail, (3) and an inductor coupled between the switching node and a load (e.g., represented by a shunt capacitive element). The high-side and low-side switches are typically implemented with transistors, although the low-side switch may alternatively be implemented with a diode.

As another example, a charge pump is a type of SMPS typically comprising at least one switching device to control the connection of a supply voltage across a load through a capacitor. In a voltage doubler (also referred to as a “multiply-by-two (X2) charge pump”), for example, the capacitor of the charge pump circuit may initially be connected across the supply, charging the capacitor to the supply voltage. The charge pump circuit may then be reconfigured to connect the capacitor in series with the supply and the load, doubling the voltage across the load. This two-stage cycle is repeated at the switching frequency for the charge pump. Charge pumps may be used to multiply or divide voltages by integer or fractional amounts, depending on the circuit topology.

Power management integrated circuits (power management ICs or PMICs) are used for managing the power scheme of a host system and may include and/or control one or more voltage regulators (e.g., buck converters or charge pumps). A PMIC may be used in battery-operated devices, such as mobile phones, tablets, laptops, wearables, etc., to control the flow and direction of electrical power in the devices. The PMIC may perform a variety of functions for the device such as DC-to-DC conversion (e.g., using a voltage regulator as described above), battery charging, power-source selection, voltage scaling, power sequencing, etc.

### SUMMARY

The systems, methods, and devices of the disclosure each have several aspects, no single one of which is solely responsible for its desirable attributes. Without limiting the scope of this disclosure as expressed by the claims that follow, some features are discussed briefly below. After considering this discussion, and particularly after reading the section entitled “Detailed Description,” one will understand how the features of this disclosure provide the advantages described herein.

Certain aspects of the present disclosure provide a power supply circuit. The power supply circuit generally includes a common output node, a first switched-mode power supply (SMPS) circuit including an output coupled to the common output node, one or more first sensors coupled to the first SMPS circuit, a second SMPS circuit including an output coupled to the common output node, one or more second sensors coupled to the second SMPS circuit, and a control circuit. The control circuit is generally configured to (i) receive, from the one or more first sensors, a first indication of a first current or a first temperature associated with the first SMPS circuit, (ii) receive, from the one or more second sensors, a second indication of a second current or a second temperature associated with the second SMPS circuit, and (iii) control, based on the first indication and the second indication, adjustment of an operating frequency of the first SMPS circuit.

Certain aspects of the present disclosure are directed to a method of supplying power. The method generally includes (i) receiving, from one or more first sensors coupled to a first switched-mode power supply (SMPS) circuit including an output coupled to a common output node, a first indication of a first current or a first temperature associated with the first SMPS circuit, (ii) receiving, from one or more second sensors coupled to a second SMPS circuit including an output coupled to the common output node, a second indication of a second current or a second temperature associated with the second SMPS circuit, and (iii) controlling, based on the first indication and the second indication, adjustment of an operating frequency of the first SMPS circuit.

Certain aspects of the present disclosure are directed to an apparatus. The apparatus generally includes: means for receiving, from one or more first sensors coupled to a first switched-mode power supply (SMPS) circuit including an output coupled to a common output node, a first indication of a first current or a first temperature associated with the first SMPS circuit; (ii) means for receiving, from one or more second sensors coupled to a second SMPS circuit including an output coupled to the common output node, a second indication of a second current or a second temperature associated with the second SMPS circuit; and (iii) means for controlling, based on the first indication and the second indication, adjustment of an operating frequency of the first SMPS circuit.

Certain aspects of the present disclosure provide an integrated circuit (e.g., a power management integrated circuit (PMIC)) comprising at least a portion of any of the power supply circuits described herein.

Certain aspects of the present disclosure provide a device (e.g., a wireless device). The device generally includes a power supply circuit as described herein and a load coupled to the common output node.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device comprising a power management system that includes a power management integrated circuit (PMIC) and a power supply circuit, in which aspects of the present disclosure may be practiced.

FIG. 2 is a circuit diagram of an example power supply circuit, in accordance with certain aspects of the present disclosure.

FIG. 3 is a circuit diagram of an example power supply circuit with operating frequency control to adjust for mismatches between two switched-mode power supply (SMPS) circuits, in accordance with certain aspects of the present disclosure.

FIGS. 4A and 4B are example plots illustrating adjustment of operating frequency for either one of two SMPS circuits in an effort to correct for current mismatch between the two SMPS circuits, in accordance with certain aspects of the present disclosure.

FIGS. 4C and 4D are example plots illustrating adjustment of operating frequency for either one of two SMPS circuits in an effort to correct for temperature mismatch between the two SMPS circuits, in accordance with certain aspects of the present disclosure.

FIG. 5A is a block diagram of an example power supply circuit with adjustment of operating frequency based on a mismatch of each of one or more slave circuits with respect to a master circuit, in accordance with certain aspects of the present disclosure.

FIG. 5B is a block diagram of an example power supply circuit with adjustment of operating frequency based on one or more mismatches between two or more circuits using a control circuit, in accordance with certain aspects of the present disclosure.

FIG. 6 is a flow diagram of example operations for supplying power, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for operating frequency adjustment for mismatched power supply circuits (e.g., power supply circuits having substantially different temperatures and/or currents), such as in a multiphase power supply circuit. Such a power supply circuit may include multiple switched-mode power supply (SMPS) circuits and be capable of adjusting an operating frequency of a first SMPS circuit of the SMPS circuits based on a difference between a first current (or a first temperature) associated with the first SMPS circuit and a second current (or a second temperature) associated with a second SMPS circuit of the SMPS circuits. For example, when the first current (or the first temperature) is higher than the second current (or the second temperature), the operating frequency of the first SMPS circuit may be decreased (e.g., incrementally) until the difference between the second current (or the second temperature) and the first current (or the first temperature) reaches an acceptable level. In another example, when the first current (or the first temperature) is lower than the second current (or the second temperature), the operating frequency of the first SMPS circuit may be increased (e.g., incrementally) until the difference between the second current (or the second temperature) and the first current (or the first temperature) reaches an acceptable level. In certain aspects, each of the SMPS circuits may be implemented with a charge pump, for example.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in any of various suitable apparatus, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDAs), and the like.

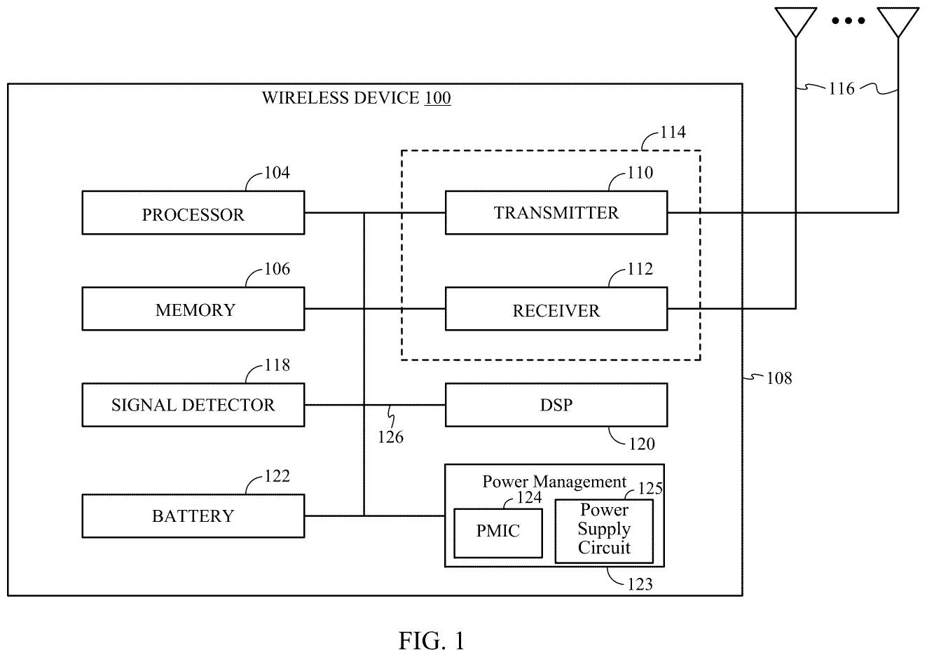

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, an Internet of things (IoT) device, a wearable device, an augmented reality device, etc. For certain aspects, the device 100 may be a foldable device (e.g., a flip phone).

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a transmitter 110 and/or a receiver 112 to allow transmission and reception of data between the device 100 and a remote location. For certain aspects, the transmitter 110 and receiver 112 may be combined into a transceiver 114. One or more antennas 116 may be attached or otherwise coupled to a housing 108 of the device 100 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when another power source—such as a wall adapter or a wireless power charger—is unavailable). The battery 122 may comprise a single cell or multiple cells connected in series and/or in parallel. The device 100 may further include additional independent batteries (not shown). Each of the additional independent batteries may comprise a single cell or multiple cells connected in series and/or in parallel.

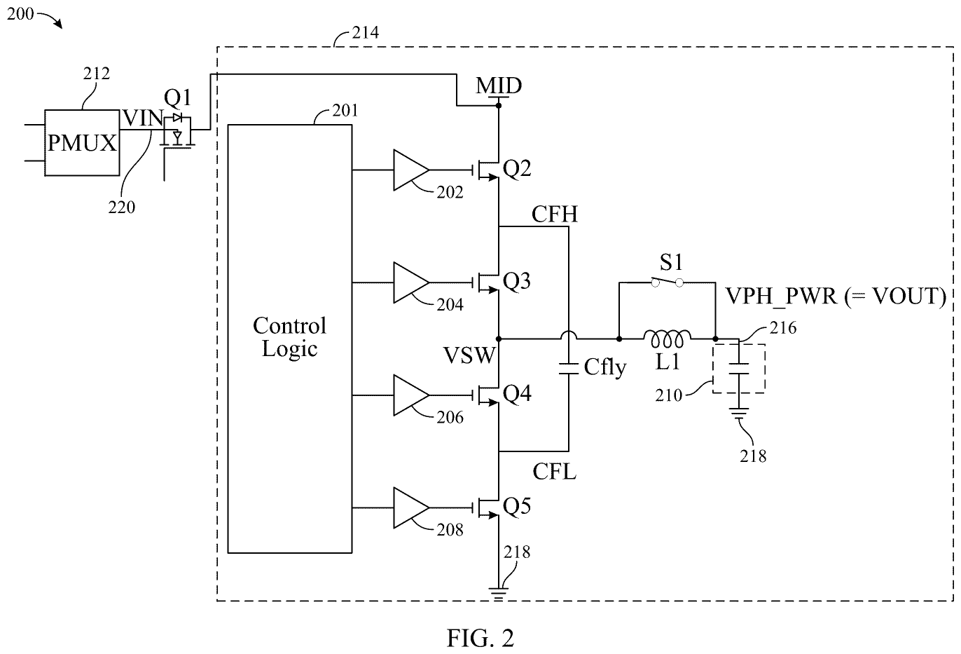

The device 100 may also include a power management system 123 for managing the power from the battery 122 (or batteries), a wall adapter, and/or a wireless power charger to the various components of the device 100. The power management system 123 may perform a variety of functions for the device such as DC-to-DC conversion, battery charging, power-source selection, voltage scaling, power sequencing, source mode power, etc. In certain aspects, the power management system 123 may include a power management integrated circuit (power management IC or PMIC) 124 and one or more power supply circuits 125, which may be controlled by the PMIC or logic associated with the battery charger, for example. For certain aspects, at least a portion of one or more of the power supply circuits 125 may be integrated in the PMIC 124. The PMIC 124 and/or the one or more power supply circuits 125 may include at least a portion of a switched-mode power supply (SMPS) circuit, which may be implemented by any of various suitable switched-mode power supply circuit topologies, such as a two-level buck converter, a three-level buck converter, a charge pump, or an adaptive combination power supply circuit (e.g., the SMPS circuit 214 of FIG. 2), which can control operating frequency, as described below.

The various components of the device 100 may be coupled together by a bus system 126, which may include a power bus, a control signal bus, and/or a status signal bus in addition to a data bus. Additionally or alternatively, various combinations of the components of the device 100 may be coupled together by one or more other suitable techniques.

### Example Power Supply Circuits and Operation

As described above, the PMIC 124 and/or the one or more power supply circuits 125 may include at least a portion of an SMPS circuit (e.g., a buck converter, a charge pump converter, or an adaptive combination power supply circuit capable of switching therebetween), which may be a single-phase or multi-phase converter. In the case of an adaptive combination power supply circuit, both converter modes may be single-phase, both converter modes may be multi-phase, one converter mode may be single-phase while the other converter mode is multi-phase or capable of changing between single-phase and multi-phase, or one converter mode may be multi-phase while the other converter mode is capable of changing between single-phase and multi-phase.

FIG. 2 is a circuit diagram of an example power supply circuit 200, which may be used to charge one or more batteries. As illustrated, the power supply circuit 200 includes a power multiplexer 212 (labeled “PMUX”), a reverse-current-blocking transistor Q1 (which may also be referred to as an overvoltage protection (OVP) field-effect transistor (FET) or an input FET), and an SMPS circuit 214 (e.g., an adaptive SMPS circuit).

The power multiplexer 212 may be configured to select between receiving power from, for example, (i) a Universal Serial Bus (USB) port for connecting to a wall adapter and (ii) a wireless power port (both not shown). The power multiplexer 212 may be implemented as a single-pole, double-throw (SPDT) switch by two OVP FETs, and in this case, transistor Q1 may be eliminated.

In certain aspects, the output of the power multiplexer 212 may be coupled to an input voltage node 220 (labeled “VIN”). The input voltage node 220 may be coupled to a source of the transistor Q1, and a drain of the transistor Q1 may be coupled to a voltage node (labeled “MID”) of the SMPS circuit 214. The MID voltage node may serve as the power supply rail of the SMPS circuit 214, and in some cases, may alternatively be considered as an input node of the SMPS circuit. In some cases, the power multiplexer 212 and/or transistor Q1 may be removed.

For certain aspects, the SMPS circuit 214 may have a two-level buck converter topology. For other aspects, the SMPS circuit 214 may have a single-phase three-level buck converter topology (as illustrated in the power supply circuit 200 of FIG. 2), and may include a second transistor Q2, a third transistor Q3, a fourth transistor Q4, a fifth transistor Q5, a flying capacitive element Cfly, an inductive element L1, and a load 210, which is represented here by a capacitor. For other aspects, the SMPS circuit 214 may have a dual-phase three-level buck converter topology. To realize an adaptive SMPS circuit, a switch S1 may be added across the inductive element L1 of the three-level buck converter topology. With the switch S1 closed, the adaptive SMPS circuit may function as a single-phase divide-by-two (Div2) charge pump converter, as further described below. In certain aspects, switch S1 may be implemented by two back-to-back transistors.

Transistor Q3 may be coupled to transistor Q2 via a first node (labeled “CFH” for flying capacitor high node), transistor Q4 may be coupled to transistor Q3 via a second node (labeled “VSW” for voltage switching node), and transistor Q5 may be coupled to transistor Q4 via a third node (labeled “CFL” for flying capacitor low node). For certain aspects, the transistors Q2-Q5 may be implemented as n-type metal-oxide-semiconductor (NMOS) transistors, as illustrated in FIG. 2. In this case, the drain of transistor Q3 may be coupled to the source of transistor Q2, the drain of transistor Q4 may be coupled to the source of transistor Q3, and the drain of transistor Q5 may be coupled to the source of transistor Q4. The source of transistor Q5 may be coupled to a reference potential node 218 (e.g., electric ground) for the power supply circuit 200. The flying capacitive element Cfly may have a first terminal coupled to the first node and a second terminal coupled to the third node. The inductive element L1 may have a first terminal coupled to the second node and a second terminal coupled to an output voltage node 216 (labeled “VOUT,” which may also be referred to as “VPH_PWR” or “VPH”) and the load 210.

Control logic 201 may control operation of the SMPS circuit 214 and other aspects of the power supply circuit 200. For example, the control logic 201 may control operation of the transistors Q5 via output signals to the inputs of respective gate drivers 202, 204, 206, and 208. The outputs of the gate drivers 202, 204, 206, and 208 are coupled to respective gates of transistors Q5. During operation of the adaptive SMPS circuit (or of a three-level buck converter), the control logic 201 may cycle through four different phases, which may differ depending on whether the duty cycle is less than 50% or greater than 50%.

Operation of the adaptive SMPS circuit with a duty cycle of less than 50% is described first. In a first phase (referred to as a “charging phase”), transistors Q2 and Q4 are activated, and transistors Q3 and Q5 are deactivated, to charge the flying capacitive element Cfly and to energize the inductive element L1. In a second phase (called a “holding phase”), transistor Q2 is deactivated, and transistor Q5 is activated, such that the VSW node is coupled to the reference potential node, the flying capacitive element Cfly is disconnected (e.g., one of the Cfly terminals is floating), and the inductive element L1 is deenergized. In a third phase (referred to as a “discharging phase”), transistors Q3 and Q5 are activated, and transistor Q4 is deactivated, to discharge the flying capacitive element Cfly and to energize the inductive element L1. In a fourth phase (also referred to as a “holding phase”), transistor Q4 is activated, and transistor Q3 is deactivated, such that the flying capacitive element Cfly is disconnected and the inductive element L1 is deenergized.

Operation of the adaptive SMPS circuit with a duty cycle greater than 50% is similar in the first and third phases, with the same transistor configurations. However, in the second phase (called a “holding phase”) following the first phase, transistor Q4 is deactivated, and transistor Q3 is activated, such that the VSW node is coupled to the MID node, the flying capacitive element Cfly is disconnected, and the inductive element L1 is energized. Similarly in the fourth phase (also referred to as a “holding phase”) with a duty cycle greater than 50%, transistor Q2 is activated, and transistor Q5 is deactivated, such that the flying capacitive element Cfly is disconnected and the inductive element L1 is energized.

Furthermore, the control logic 201 may have a control signal (not shown in FIG. 2) configured to control operation of switch S1 and selectively enable divide-by-two (Div2) charge pump operation. For certain aspects, when this control signal is logic low, switch S1 is open, and the power supply circuit 200 operates as a three-level buck converter using the inductive element L1. When this control signal is logic high for certain aspects, switch S1 is closed, thereby shorting across the inductive element L1 and effectively removing the inductive element L1 from the circuit, such that the adaptive SMPS circuit operates as a Div2 charge pump. The control logic 201 may be configured to automatically control operation of switch S1 (e.g., through the logic level of the control signal) based on an output current (also referred to as a “load current”) and/or an input current for the adaptive SMPS circuit.

### Example Operating Frequency Adjustment

Devices may utilize power supply circuits (e.g., multiphase power supply circuits) that include multiple switched-mode power supply of (SMPS) circuits to regulate power during device operation. For example, a power supply circuit may include two or more charge pumps coupled to a common output. However, in some cases, there may exist one or more mismatches between the multiple SMPS circuits in the power supply circuit of the device. The mismatch(es) between the SMPS circuits may result in current unbalance, thermal unbalance, power field-effect transistor (FET) stress differences, and/or device lifetime differences. The source(s) of the mismatch(es) between the SMPS circuits may, for example, be due to: (i) printed circuit board (PCB) resistance mismatch at the inputs of the SMPS circuits, (ii) PCB resistance mismatch at the outputs of the SMPS circuits, (iii) flying capacitor mismatch in the SMPS circuits, (iv) operating frequency mismatch between the SMPS circuits, and/or (v) drain-to-source on-resistance (R_{DSon}) mismatch between metal-oxide-semiconductor field-effect transistors (MOSFETs) in the SMPS circuits. The mismatch(es) between the SMPS circuits may be especially problematic when the power supply circuit is operating in a high current mode, as the mismatched SMPS circuit with the highest current will be under increased stress.

Certain aspects of the present disclosure provide techniques and apparatus for adjusting operating frequency of at least one of the SMPS circuits to compensate (or at least adjust) for the mismatch(es) between the SMPS circuits included in a power supply circuit. Such a power supply circuit may be capable of (i) sensing a difference between a first current (or a first temperature) associated with a first SMPS circuit and a second current (or a second temperature) associated with a second SMPS circuit and (ii) adjusting (e.g., increasing or decreasing) an operating frequency of the first SMPS circuit and/or the second SMPS circuit accordingly.

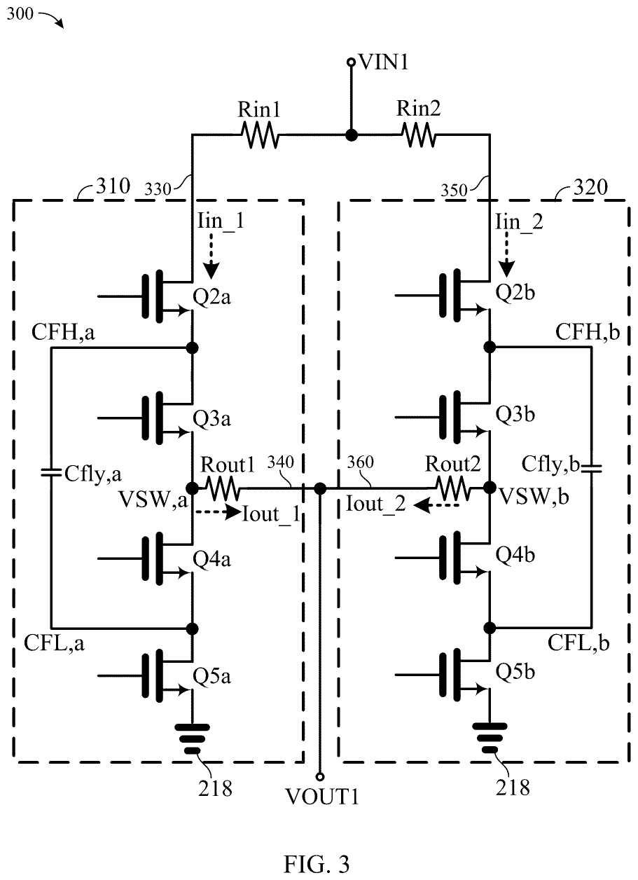

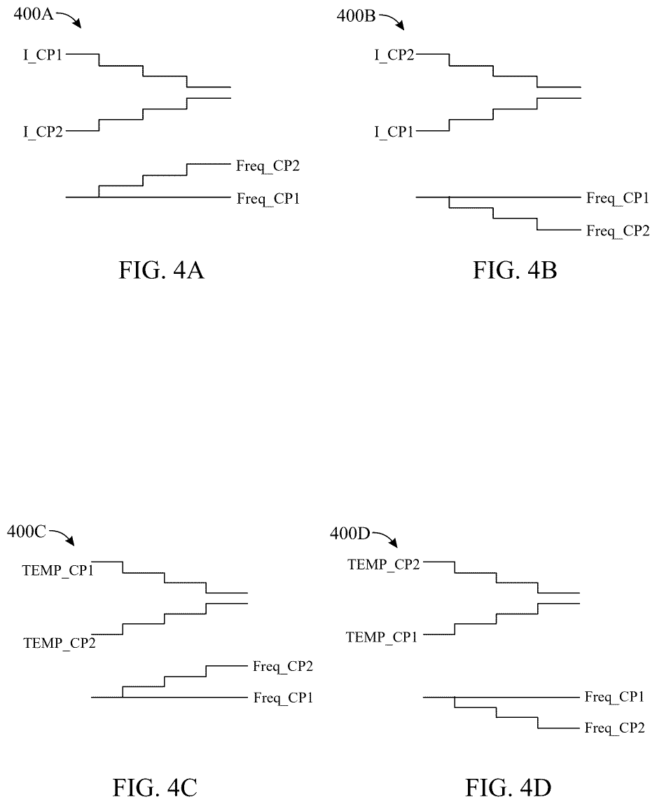

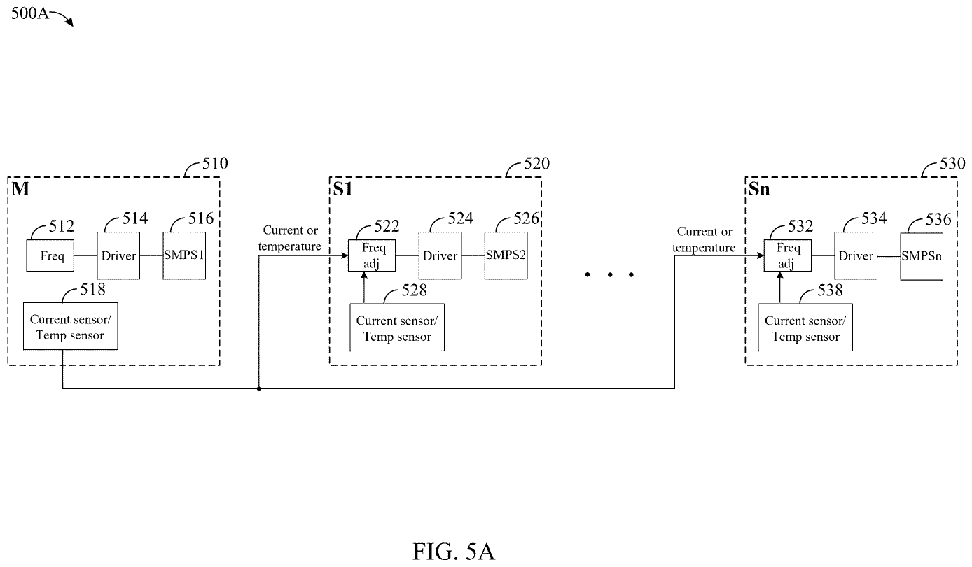

FIG. 3 is a circuit diagram of an example power supply circuit 300 with operating frequency control to adjust for mismatches between two SMPS circuits (e.g., a first SMPS circuit 310 and a second SMPS circuit 320), in accordance with certain aspects of the present disclosure. FIGS. 4A and 4B are example plots 400A and 400B illustrating adjustment of operating frequency for either one of two SMPS circuits (e.g., the first SMPS circuit 310 or the second SMPS circuit 320) in an effort to correct for current mismatch between the two SMPS circuits, in accordance with certain aspects of the present disclosure. FIGS. 4C and 4D are example plots 400C and 400D illustrating adjustment of operating frequency for either one of two SMPS circuits (e.g., the first SMPS circuit 310 or the second SMPS circuit 320) in an effort to correct for temperature mismatch between the two SMPS circuits, in accordance with certain aspects of the present disclosure. Due to their relationship, FIGS. 3 and 4A-4D are herein described together for clarity.

The first SMPS circuit 310 may include transistor Q2a (similar to transistor Q2), transistor Q3a (similar to transistor Q3), transistor Q4a (similar to transistor Q4), transistor Q5a (similar to transistor Q5), and a flying capacitive element Cfly, a (similar to flying capacitive element Cfly). Similarly, the second SMPS circuit 320 may include transistor Q2b (similar to transistor Q2), transistor Q3b (similar to transistor Q3), transistor Q4b (similar to transistor Q4), transistor Q5b (similar to transistor Q5), and a flying capacitive element Cfly, b (similar to flying capacitive element Cfly). In certain aspects, the first SMPS circuit 310 and the second SMPS circuit 320 may each be implemented with charge pumps, as illustrated. It is to be understood that when implemented as charge pumps, the first SMPS circuit 310 and the second SMPS circuit 320 may be implemented with any charge pump structure, such as charge pumps with any suitable input-to-output ratio (e.g., 3:1, 4:1, 4:2, etc.).

Referring to the first SMPS circuit 310, transistor Q3a may be coupled to transistor Q2a via a first node (labeled “CFH, a” for flying capacitor high node), transistor Q4a may be coupled to transistor Q3a via a second node (labeled “VSW, a” for voltage switching node), and transistor Q5a may be coupled to transistor Q4a via a third node (labeled “CFL, a” for flying capacitor low node). For certain aspects, the transistors Q2a-Q5a may be implemented as n-type metal-oxide-semiconductor (NMOS) transistors, as illustrated in FIG. 3. In this case, the drain of transistor Q3a may be coupled to the source of transistor Q2a, the drain of transistor Q4a may be coupled to the source of transistor Q3a, and the drain of transistor Q5a may be coupled to the source of transistor Q4a. The source of transistor Q5a may be coupled to the reference potential node 218 (e.g., electric ground) for the power supply circuit 300. The flying capacitive element Cfly, a may have a first terminal coupled to the first node CFH, a and a second terminal coupled to the third node CFL, a. An input 330 of the first SMPS circuit 310 (e.g., coupled to a drain of transistor Q2a) may be coupled to a common input node (labeled “VIN1”), and an output 340 of the first SMPS circuit 310 (e.g., coupled to the second node VSW, a) may be coupled to a common output node (labeled “VOUT1”), as illustrated. The common input node VIN1 may be coupled to a power supply rail (not shown) or other power supply source, and the common output node VOUT1 may be coupled to a load, which may represent one or more circuits of a device (e.g., the device 100 of FIG. 1).

Referring to the second SMPS circuit 320, transistor Q3b may be coupled to transistor Q2b via a fourth node (labeled “CFH, b” for flying capacitor high node), transistor Q4b may be coupled to transistor Q3b via a fifth node (labeled “VSW, b” for voltage switching node), and transistor Q5b may be coupled to transistor Q4b via a sixth node (labeled “CFL, b” for flying capacitor low node). For certain aspects, the transistors Q2b-Q5b may be implemented as NMOS transistors, as illustrated in FIG. 3. In this case, the drain of transistor Q3b may be coupled to the source of transistor Q2b, the drain of transistor Q4b may be coupled to the source of transistor Q3b, and the drain of transistor Q5b may be coupled to the source of transistor Q4b. The source of transistor Q5b may be coupled to the reference potential node 218 for the power supply circuit 300. The flying capacitive element Cfly, b may have a first terminal coupled to the fourth node CFH, b and a second terminal coupled to the sixth node CFL, b. An input 350 of the second SMPS circuit 320 (e.g., coupled to a drain of transistor Q2b) may be coupled to the common input node VIN1, and an output 360 of the second SMPS circuit 320 (e.g., coupled to the fifth node VSW, b) may be coupled to the common output node VOUT1, as illustrated.

In certain aspects, one or more resistive elements Rin1 may be coupled or present between the input 330 of the first SMPS circuit 310 and the common input node VIN1, and one or more resistive elements Rin2 may be coupled between the input 350 of the second SMPS circuit 320 and the common input node VIN1. The one or more resistive elements Rin1 may represent the intrinsic path resistance between the input 330 of the first SMPS circuit 310 and a power source (e.g., the battery 122 of FIG. 1) of the power supply circuit 300, while the one or more resistive elements Rin2 may represent the intrinsic path resistance between the input 350 of the second SMPS circuit 320 and the power source.

In certain aspects, one or more resistive elements Rout1 may be coupled or present between the output 340 of the first SMPS circuit 310 and the common output node VOUT1, and one or more resistive elements Rout2 may be coupled between the output 360 of the second SMPS circuit 320 and the common output node VOUT1. The one or more resistive elements Rout1 may represent the intrinsic path resistance between the output 340 of the first SMPS circuit 310 and the load (e.g., which is coupled to the common output node), while the one or more resistive elements Rout2 may represent the intrinsic path resistance between the output 360 of the second SMPS circuit 320 and the load.

In certain aspects, one or more first sensors (not shown) may be coupled to the first SMPS circuit 310, and one or more second sensors (also not shown) may be coupled to the second SMPS circuit 320. In some cases, the one or more first sensors may be included in the first SMPS circuit 310, and the one or more second sensors may be included in the second SMPS circuit 320. In certain aspects, the one or more first sensors may include (or be implemented as) one or more first current sensors that may include the one or more resistive elements Rin1 and/or Rout1, and the one or more second sensors may include (or be implemented as) one or more second current sensors that may include the one or more second resistive elements Rin2 and/or Rout2. In other aspects, the one or more first sensors may include (or be implemented as) one or more first temperature sensors, and the one or more second sensors may include (or be implemented as) one or more second temperature sensors. In yet other aspects, the one or more first sensors may be include (or be implemented as) one or more first current sensors and one or more first temperature sensors, and the one or more second sensors may include (or be implemented as) one or more second current sensors and one or more second temperature sensors.

According to certain aspects, the power supply circuit 300 may include a control circuit (not shown in FIG. 3, but similar, for example, to control logic 201 in FIG. 2) configured to control operating frequencies of the first SMPS circuit 310 and the second SMPS circuit 320 by sending control signals to the gates of the transistors Q2a-Q5a and Q2b-Q5b (e.g., via gate drivers, such as gate drivers 202, 204, 206, 208). The control circuit may be configured to (i) receive, from the one or more first sensors, a first indication of a first current or a first temperature associated with the first SMPS circuit 310, (ii) receive, from the one or more second sensors, a second indication of a second current or a second temperature associated with the second SMPS circuit 320, and (iii) control, based on the first indication and the second indication, adjustment of an operating frequency of the first SMPS circuit 310 and/or an operating frequency of the second SMPS circuit 320. In this manner, the operating frequency of an SMPS circuit (e.g., the first SMPS circuit 310) may be increased when the temperature and/or the current associated with the SMPS circuit is lower than another SMPS circuit (e.g., the second SMPS circuit 320), and the operating frequency of the SMPS circuit may be decreased when the temperature and/or the current associated with the SMPS circuit is higher than the other SMPS circuit. That is, the operating frequency of an SMPS circuit may be adjusted when a mismatch between SMPS circuits is sensed.

In some cases, the first current associated with the first SMPS circuit 310 may be a first output current (labeled “Iout_1”) through the output 340 of the first SMPS circuit 310, and the second current associated with the second SMPS circuit 320 may be a second output current (labeled “Iout_2”) through the output 360 of the second SMPS circuit 320. In other cases, the first current associated with the first SMPS circuit 310 may be a first input current (labeled “Iin_1”) through the input 330 of the first SMPS circuit 310, and the second current associated with the second SMPS circuit 320 may be a second input current (labeled “Iin_2”) through the input 350 of the second SMPS circuit 320.

In a first scenario, to control adjustment of the operating frequency of the first SMPS circuit 310, the control circuit may be configured to control decreasing the operating frequency of the first SMPS circuit 310 when the first current (or the first temperature) associated with the first SMPS circuit 310 is higher than the second current (or the second temperature) associated with the second SMPS circuit 320. The control circuit may control the reduction of the operating frequency until a difference between the second current (or the second temperature) and the first current (or the first temperature) is less than a first threshold. In some cases, the control circuit may be configured to control decreasing the operating frequency of the first SMPS circuit 310 dependent on the first current (or the first temperature) being higher than a second threshold. In this manner, the operating frequency of the first SMPS circuit 310 may not be decreased until the first current (or the first temperature) is sufficiently high (e.g., higher than the second threshold). In this case, the first threshold is lower than the second threshold.

In a second scenario, to control adjustment of the operating frequency of the first SMPS circuit 310, the control circuit may be configured to control increasing the operating frequency of the first SMPS circuit 310 when the first current (or the first temperature) associated with the first SMPS circuit 310 is lower than the second current (or the second temperature) associated with the second SMPS circuit 320. The control circuit may control the increase of the operating frequency until a difference between the second current (or the second temperature) and the first current (or the first temperature) is less than a third threshold. In some cases, the control circuit may be configured to control increasing the operating frequency of the first SMPS circuit 310 dependent on the first current (or the first temperature) being lower than a fourth threshold. In this manner, the operating frequency of the first SMPS circuit 310 may not be increased until the first current (or the first temperature) is sufficiently low (e.g., lower than the fourth threshold). In this case, the third threshold is higher than the fourth threshold.

In a third scenario, to control adjustment of the operating frequency of the second SMPS circuit 320, the control circuit may be configured to control decreasing the operating frequency of the second SMPS circuit 320 when the second current (or the second temperature) associated with the second SMPS circuit 320 is higher than the first current (or the first temperature) associated with the first SMPS circuit 310. The control circuit may control the reduction of the operating frequency until a difference between the first current (or the first temperature) and the second current (or the second temperature) is less than a fifth threshold. In some cases, the control circuit may be configured to control decreasing the operating frequency of the second SMPS circuit 320 dependent on the second current (or the second temperature) being higher than a sixth threshold. In this manner, the operating frequency of the second SMPS circuit 320 may not be decreased until the second current (or the second temperature) is sufficiently high (e.g., higher than the sixth threshold). In this case, the fifth threshold is lower than the sixth threshold.

For example, and as illustrated in FIG. 4B, the control circuit may be configured to control decreasing the operating frequency of the second SMPS circuit 320 (labeled “Freq_CP2”) (while maintaining the operating frequency of the first SMPS circuit, labeled “Freq_CP1”) when the second current associated with the second SMPS circuit 320 (labeled “I_CP2”) is higher than the first current associated with the first SMPS circuit 310 (labeled “I_CP1”). The operating frequency of the second SMPS circuit 320 may be reduced incrementally, in steps, as shown in FIG. 4B. In this example, decreasing the operating frequency of the second SMPS circuit 320 results in the second current and the first current becoming increasingly balanced until a predefined level of balance (e.g., within a threshold difference) is reached, as shown.

In another example, and as illustrated in FIG. 4D, the control circuit may be configured to control decreasing the operating frequency of the second SMPS circuit 320 (labeled “Freq_CP2”) (while maintaining the operating frequency of the first SMPS circuit, labeled “Freq_CP1”) when the second temperature associated with the second SMPS circuit 320 (labeled “TEMP_CP2”) is higher than the first temperature associated with the first SMPS circuit 310 (labeled “TEMP_CP1”). In this example, decreasing the operating frequency of the second SMPS circuit 320 results in the second temperature and the first temperature becoming increasingly balanced until a predefined level of balance (e.g., within a threshold difference) is reached, as shown.

In a fourth scenario, to control adjustment of the operating frequency of the second SMPS circuit 320, the control circuit may be configured to control increasing the operating frequency of the second SMPS circuit 320 when the second current (or the second temperature) associated with the second SMPS circuit 320 is lower than the first current (or the first temperature) associated with the first SMPS circuit 310. The control circuit may control the increase of the operating frequency until a difference between the first current (or the first temperature) and the second current (or the second temperature) is less than a seventh threshold. In some cases, the control circuit may be configured to control increasing the operating frequency of the second SMPS circuit 320 dependent on the second current (or the second temperature) being lower than an eighth threshold. In this manner, the operating frequency of the second SMPS circuit 320 may not be increased until the second current (or the second temperature) is sufficiently low (e.g., lower than the eighth threshold). In this case, the seventh threshold is higher than the eighth threshold.

For example, and as illustrated in FIG. 4A, the control circuit may be configured to control increasing the operating frequency of the second SMPS circuit 320 (labeled “Freq_CP2”) (while maintaining the operating frequency of the first SMPS circuit, labeled “Freq_CP1”) when the second current associated with the second SMPS circuit 320 (labeled “I_CP2”) is lower than the first current associated with the first SMPS circuit 310 (labeled “I_CP1”). The operating frequency of the second SMPS circuit 320 may be increased incrementally, in steps, as shown in FIG. 4A. In this example, increasing the operating frequency of the second SMPS circuit 320 results in the first current and the second current becoming increasingly balanced until a predefined level of balance (e.g., within a threshold difference) is reached, as shown.

In another example, and as illustrated in FIG. 4C, the control circuit may be configured to control increasing the operating frequency of the second SMPS circuit 320 (labeled “Freq_CP2”) (while maintaining the operating frequency of the first SMPS circuit, labeled “Freq_CP1”) when the second temperature associated with the second SMPS circuit 320 (labeled “TEMP_CP2”) is lower than the first temperature associated with the first SMPS circuit 310 (labeled “TEMP_CP1”). In this example, increasing the operating frequency of the second SMPS circuit 320 results in the second temperature and the first temperature becoming increasingly balanced until a predefined level of balance (e.g., within a threshold difference) is reached, as shown.

In some cases, the control circuit may be configured to control adjustment of the operating frequency of the first SMPS circuit 310 and/or the second SMPS circuit 320 incrementally over a period of time (e.g., by adjusting the operating frequency in steps, as shown in FIGS. 4A-4D). In other cases, the control circuit may be configured to control adjustment of the operating frequency of the first SMPS circuit 310 and/or the second SMPS circuit 320 by making a single adjustment to the operating frequency.

In some cases, the first SMPS circuit 310 may be disposed on a first integrated circuit (IC), and the second SMPS circuit 320 may be disposed on a second IC different from the first IC. In these cases, the control circuit may be disposed on the first IC, the second IC, or another IC. Alternatively, the control circuit may be distributed among multiple ICs. In other cases, the first SMPS circuit 310 may be disposed on the same IC as the second SMPS circuit 320. In these cases, the control circuit may be disposed on the same IC as the first SMPS circuit 310 and the second SMPS circuit 320, or on another IC. In certain aspects, separate gate driver circuits (not shown) may be coupled to gates of each of the transistors Q2a-Q5a and Q2b-Q5b to control operation of the first SMPS circuit 310 and the second SMPS circuit 320, respectively, via control inputs received from the control circuit.

It is to be understood that even though only two SMPS circuits are illustrated in the power supply circuit 300, any number of SMPS circuits (e.g., coupled in parallel) may be included. For example, the power supply circuit 300 may additionally include one or more third sensors coupled to a third SMPS circuit. The third SMPS circuit includes an input coupled to the common input node and an output coupled to the common output node. In this example, the control circuit may be configured to receive, from the one or more third sensors, a third indication of a third current or a third temperature associated with the third SMPS circuit, and control adjustment of an operating frequency of the third SMPS circuit (and/or the first SMPS circuit 310 and/or the second SMPS circuit 320) based on the first indication (e.g., of the first current or the first temperature associated with the first SMPS circuit 310), the second indication (e.g., of the second current or the second temperature associated with the second SMPS circuit 320), and/or the third indication.

In certain aspects, the control circuit may be configured to adjust the operating frequency of the first SMPS circuit 310 and the operating frequency of the second SMPS circuit 320 concurrently. For example, to control adjustment of the operating frequency of the first SMPS circuit 310 and/or the second SMPS circuit 320, the control circuit may be configured to control increasing the operating frequency of the first SMPS circuit 310 and decreasing the operating frequency of the second SMPS circuit 320 concurrently when the first current (or the first temperature) associated with the first SMPS circuit 310 is lower than the second current (or the second temperature) associated with the second SMPS circuit 320. The control circuit may be configured to concurrently control adjusting the operating frequencies of both circuits 310, 320 until a difference between the first current (or the first temperature) and the second current (or the second temperature) is less than a ninth threshold.

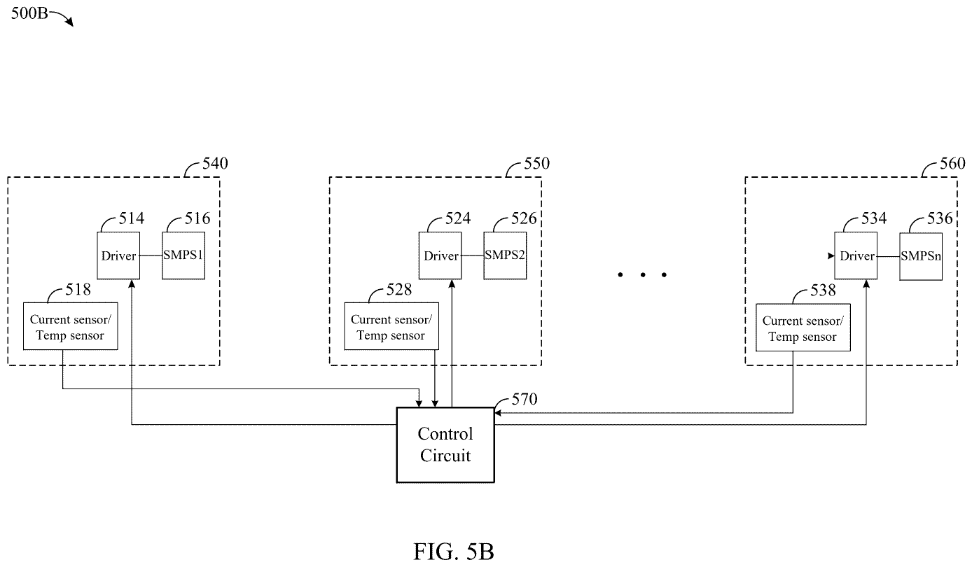

FIG. 5A is a block diagram of an example power supply circuit 500A capable of adjusting operating frequency based on a mismatch of each of one or more slave circuits 520 and 530 (labeled “S1” and “Sn,” respectively) with respect to a master circuit 510 (labeled “M”), in accordance with certain aspects of the present disclosure. The master circuit 510 and the slave circuits 520, 530 may represent different subcircuits of a multiphase power supply circuit, for example. Although two slave circuits 520 and 530 are shown included in the power supply circuit 500A, any number n of slave circuits (each with an associated SMPS circuit) may be included. The master circuit 510 may include a frequency circuit 512 (labeled “Freq”), a driver 514, a first SMPS circuit 516 (labeled “SMPS1”), and one or more current and/or temperature sensors 518 (labeled “Current sensor/Temp sensor). The driver 514 may be supplied with a control signal from the frequency circuit 512 to control operation of the first SMPS circuit 516 with a particular operating frequency. In some cases, each of the master circuit 510, the slave circuit 520, and the slave circuit 530 may be disposed on an individual IC. In other cases, any combination of the master circuit 510, the slave circuit 520, and the slave circuit 530 may be disposed together on an IC, and the remaining circuit may disposed on one or more other ICs.

The slave circuit 520 may include a first frequency adjuster circuit 522 (labeled “Freq adj”), a driver 524, a second SMPS circuit 526 (labeled “SMPS1”), and one or more current and/or temperature sensors 528 (labeled “Current sensor/Temp sensor). The driver 524 may receive a control signal from the first frequency adjuster circuit 522 that may effectively adjust the operating frequency of the second SMPS circuit 526 (compared to the operating frequency of the first SMPS circuit 516).

The slave circuit 530 may include a second frequency adjuster circuit 532 (labeled “Freq adj”), a driver 534, a third SMPS circuit 536 (labeled “SMPSn”), and one or more current and/or temperature sensors 538 (labeled “Current sensor/Temp sensor). The driver 534 may receive a control signal from the second frequency adjuster circuit 532 that may effectively adjust the operating frequency of the third SMPS circuit 536 (compared to the operating frequency of the first SMPS circuit 516).

According to certain aspects, the master circuit 510 may provide an indication of a first current and/or a first temperature associated with the first SMPS circuit 516 to the slave circuits 520 and 530. The slave circuit 520 (e.g., a control circuit included in the slave circuit 520, such as the frequency adjuster circuit 522) may compare the first current and/or the first temperature with a second current and/or a second temperature associated with the second SMPS circuit 526 and adjust the operating frequency of the second SMPS circuit 526 accordingly (e.g., via the driver 524). In a similar manner, the other slave circuit(s) may compare the first current and/or the first temperature with another current and/or another temperature associated with a respective SMPS circuit and adjust the operating frequency thereof. For example, the slave circuit 530 (e.g., a control circuit included in the slave circuit 530, such as the frequency adjuster circuit 532) may compare the first current and/or the first temperature with a third current and/or a third temperature associated with the third SMPS circuit 536 and adjust the operating frequency of the third SMPS circuit 536 accordingly (e.g., via the driver 534). In this manner, each of the slave circuits may individually adjust the operating frequency of their respective SMPS circuits based on the first indication from the master circuit 510. It is to be understood that any of the circuits 510, 520 or 530 may serve as the master circuit (e.g., considered to have the reference current and/or reference temperature) for the comparison of the temperature and/or current between the SMPS circuits.

The operating frequency adjustment in the power supply circuit 500A may be performed in the manner described above. That is, the operating frequency of an SMPS circuit (e.g., the second SMPS circuit 526 and/or the third SMPS circuit 536) may be increased when the temperature and/or current associated with the SMPS circuit is lower than another SMPS circuit (e.g., the first SMPS circuit 516), and the operating frequency of the SMPS circuit may be decreased when the temperature and/or current associated with the SMPS circuit is higher than the other SMPS circuit. In this manner, the operating frequency of an SMPS circuit may be adjusted when a mismatch between SMPS circuits occurs.

FIG. 5B is a block diagram of an example power supply circuit 500B capable of adjusting operating frequency based on one or more mismatches between two or more subcircuits using a control circuit 570, in accordance with certain aspects of the present disclosure. The subcircuits may represent different subcircuits of a multiphase power supply circuit, for example. The one or more subcircuits may include a subcircuit 540, a subcircuit 550, and a subcircuit 560. Although three subcircuits 540, 550, and 560 are shown included in the power supply circuit 500B, any multiple number n of subcircuits (each with an associated SMPS circuit) may be included.

The subcircuit 540 may be similar to the master circuit 510, but may not include the frequency circuit 512. The subcircuits 550 and 560 may be similar to the slave circuits 520 and 530, respectively, but may not include the first frequency adjuster circuit 522 and the second frequency adjuster circuit 532. Instead, and as illustrated in FIG. 5B, the control circuit 570 may receive (i) a first indication of a first current and/or a first temperature associated with the first SMPS circuit 516, (ii) a second indication of a second current and/or a second temperature associated with the second SMPS circuit 526, and (iii) a third indication of a third current and/or a third temperature associated with the third SMPS circuit 536. Based on the received indications, the control circuit 570 may generate control signals to control the driver 514, the driver 524, and/or the driver 534 to adjust the operating frequencies of the first SMPS circuit 516, the second SMPS circuit 526, and the third SMPS circuit 536, respectively.

The operating frequency adjustment in the power supply circuit 500B may be performed in the manner described above. That is, the operating frequency of an SMPS circuit (e.g., the first SMPS circuit 516, the second SMPS circuit 526, and/or the third SMPS circuit 536) may be increased when the temperature and/or current associated with the SMPS circuit is lower than one or more other SMPS circuits (e.g., the first SMPS circuit 516, the second SMPS circuit 526, and/or the third SMPS circuit 536), and the operating frequency of the SMPS circuit may be decreased when the temperature and/or current associated with the SMPS circuit is higher than the one or more other SMPS circuits. It is to be understood that any one of the subcircuits 540, 550, and 560 may serve as the reference for the comparison of the temperature and/or current between the SMPS circuits.

In some cases, each of the subcircuits 540, 550, and 560 may be disposed on an individual IC. In these cases, the control circuit 570 may be disposed on the same IC as the subcircuit 540, the same IC as the subcircuit 550, the same IC as the subcircuit 560, or on another IC. In other cases, any combination of the subcircuit 540, the subcircuit 550, the subcircuit 560, and the control circuit 570 may be disposed together on an IC, and the remaining circuits may disposed on one or more other ICs.

### Example Power Supply Operations

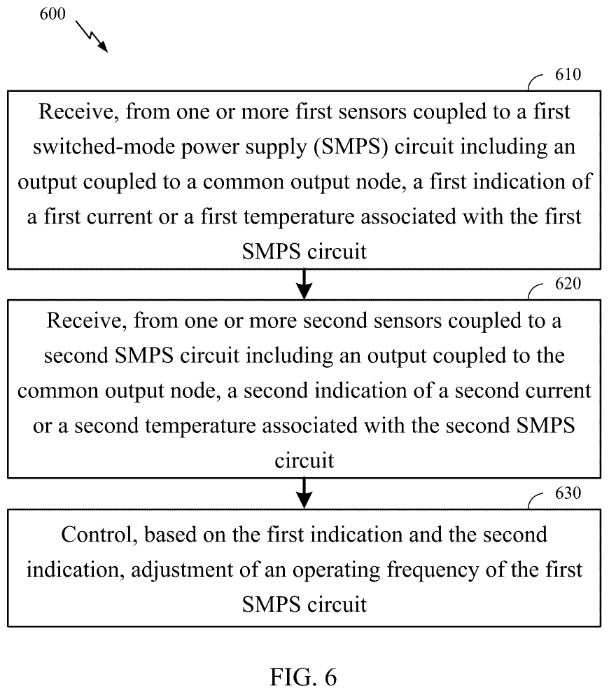

FIG. 6 is a flow diagram of example operations 600 for supplying power, in accordance with certain aspects of the present disclosure. The operations 600 may be performed by a power supply circuit (e.g., the power supply circuit 300, 500A, 500B of FIGS. 3, 5A, and 5B, respectively).

The operations 600 may include, at block 610, receiving, from one or more first sensors (e.g., one or more current and/or temperature sensors 518, 528, or 538) coupled to a first switched-mode power supply (SMPS) circuit (e.g., first SMPS circuit 310 or 516, second SMPS circuit 320 or 526, or third SMPS circuit 536) including an output (e.g., output 340 or output 360) coupled to a common output node (e.g., common output node VOUT1), a first indication of a first current or a first temperature associated with the first SMPS circuit.

At block 620, the operations 600 may include receiving, from one or more second sensors (e.g., one or more current and/or temperature sensors 518, 528, or 538) coupled to a second SMPS circuit (e.g., first SMPS circuit 310 or 516, second SMPS circuit 320 or 526, or third SMPS circuit 536) including an output (e.g., output 340 or output 360) coupled to the common output node, a second indication of a second current or a second temperature associated with the second SMPS circuit.

At block 630, the operations 600 may include controlling, based on the first indication and the second indication, adjustment of an operating frequency of the first SMPS circuit.

In some cases, controlling the adjustment of the operating frequency may include decreasing the operating frequency of the first SMPS circuit when the first current or the first temperature associated with the first SMPS circuit is higher than the second current or the second temperature associated with the second SMPS circuit, respectively, until a difference between the second current or the second temperature and the first current or the first temperature, respectively, is less than a first threshold. In these cases, decreasing the operating frequency may depend on the first current or the first temperature being higher than a second threshold.

In some cases, controlling the adjustment of the operating frequency may include increasing the operating frequency of the first SMPS circuit when the first current or the first temperature associated with the first SMPS circuit is lower than the second current or the second temperature associated with the second SMPS circuit, respectively, until a difference between the first current or the first temperature and the second current or the second temperature, respectively, is less than a first threshold. In these cases, increasing the operating frequency may depend on the first current or the first temperature being lower than a second threshold.

According to certain aspects, the first SMPS circuit may include a first charge pump circuit, and the second SMPS circuit may include a second charge pump circuit. In certain aspects, the power supply circuit may include a multiphase power supply circuit (e.g., a multiphase charge pump circuit) comprising the first and second SMPS circuits.

According to certain aspects, the first current associated with the first SMPS circuit may be a first output current (e.g., first output current Iout_1 or second output current Iout_2) through the output of the first SMPS circuit and the second current associated with the second SMPS circuit may be a second output current (e.g., first output current Iout_1 or second output current Iout_2) through the output of the second SMPS circuit.

### Example Aspects

In addition to the various aspects described above, specific combinations of aspects are within the scope of the disclosure, some of which are detailed below:
Aspect 1: A power supply circuit comprising: a common output node; a first switched-mode power supply (SMPS) circuit including an output coupled to the common output node; one or more first sensors coupled to the first SMPS circuit; a second SMPS circuit including an output coupled to the common output node; one or more second sensors coupled to the second SMPS circuit; and a control circuit configured to: receive, from the one or more first sensors, a first indication of a first current or a first temperature associated with the first SMPS circuit; receive, from the one or more second sensors, a second indication of a second current or a second temperature associated with the second SMPS circuit; and control, based on the first indication and the second indication, adjustment of an operating frequency of the first SMPS circuit.
Aspect 2: The power supply circuit of Aspect 1, wherein to control adjustment of the operating frequency of the first SMPS circuit, the control circuit is configured to control decreasing the operating frequency of the first SMPS circuit when the first current or the first temperature associated with the first SMPS circuit is higher than the second current or the second temperature associated with the second SMPS circuit, respectively, until a difference between the second current or the second temperature and the first current or the first temperature, respectively, is less than a first threshold.
Aspect 3: The power supply circuit of Aspect 2, wherein the control circuit is configured to control decreasing the operating frequency of the first SMPS circuit dependent on the first current or the first temperature being higher than a second threshold.
Aspect 4: The power supply circuit according to any of Aspects 1-3, wherein to control adjustment of the operating frequency of the first SMPS circuit, the control circuit is configured to control increasing the operating frequency of the first SMPS circuit when the first current or the first temperature associated with the first SMPS circuit is lower than the second current or the second temperature associated with the second SMPS circuit, respectively, until a difference between the first current or the first temperature and the second current or the second temperature, respectively, is less than a first threshold.
Aspect 5: The power supply circuit of Aspect 4, wherein the control circuit is configured to control increasing the operating frequency of the first SMPS circuit dependent on the first current or the first temperature being lower than a second threshold.
Aspect 6: The power supply circuit according to any of Aspects 1-5, wherein the first SMPS circuit comprises a first charge pump circuit and wherein the second SMPS circuit comprises a second charge pump circuit.
Aspect 7: The power supply circuit according to any of Aspects 1-6, wherein the one or more first sensors comprise a first current sensor including a first resistive element coupled between the output of the first SMPS circuit and the common output node and wherein the one or more second sensors comprise a second current sensor including a second resistive element coupled between the output of the second SMPS circuit and the common output node.
Aspect 8: The power supply circuit according to any of Aspects 1-7, wherein the first current associated with the first SMPS circuit is a first output current through the output of the first SMPS circuit and wherein the second current associated with the second SMPS circuit is a second output current through the output of the second SMPS circuit.
Aspect 9: The power supply circuit according to any of Aspects 1-7, wherein the first current associated with the first SMPS circuit is a first input current through an input of the first SMPS circuit and wherein the second current associated with the second SMPS circuit is a second input current through an input of the second SMPS circuit.
Aspect 10: The power supply circuit according to any of Aspects 1-9, wherein the first SMPS circuit is disposed on a first integrated circuit and wherein the second SMPS circuit is disposed on a second integrated circuit different from the first integrated circuit.
Aspect 11: The power supply circuit of Aspect 10, wherein the control circuit is disposed on the first integrated circuit.
Aspect 12: The power supply circuit according to any of Aspects 1-11, wherein the control circuit is configured to control adjustment of the operating frequency of the first SMPS circuit incrementally over a period of time.
Aspect 13: The power supply circuit according to any of Aspects 1-12, further comprising: a third SMPS circuit including an output coupled to the common output node; and one or more third sensors coupled to the third SMPS circuit, wherein the control circuit is further configured to: receive, from the one or more third sensors, a third indication of a third current or a third temperature associated with the third SMPS circuit; and control adjustment of an operating frequency of the third SMPS circuit based on the second indication and the third indication.
Aspect 14: A method of supplying power, the method comprising: receiving, from one or more first sensors coupled to a first SMPS circuit including an output coupled to a common output node, a first indication of a first current or a first temperature associated with the first SMPS circuit; receiving, from one or more second sensors coupled to a second SMPS circuit including an output coupled to the common output node, a second indication of a second current or a second temperature associated with the second SMPS circuit; and controlling, based on the first indication and the second indication, adjustment of an operating frequency of the first SMPS circuit.
Aspect 15: The method of Aspect 14, wherein controlling the adjustment of the operating frequency comprises decreasing the operating frequency of the first SMPS circuit when the first current or the first temperature associated with the first SMPS circuit is higher than the second current or the second temperature associated with the second SMPS circuit, respectively, until a difference between the second current or the second temperature and the first current or the first temperature, respectively, is less than a first threshold.
Aspect 16: The method of Aspect 15, wherein decreasing the operating frequency depends on the first current or the first temperature being higher than a second threshold.
Aspect 17: The method according to any of Aspects 14-16, wherein controlling the adjustment of the operating frequency comprises increasing the operating frequency of the first SMPS circuit when the first current or the first temperature associated with the first SMPS circuit is lower than the second current or the second temperature associated with the second SMPS circuit, respectively, until a difference between the first current or the first temperature and the second current or the second temperature, respectively, is less than a first threshold.
Aspect 18: The method of Aspect 17, wherein increasing the operating frequency depends on the first current or the first temperature being lower than a second threshold.
Aspect 19: The method according to any of Aspects 14-18, wherein the first SMPS circuit comprises a first charge pump circuit and wherein the second SMPS circuit comprises a second charge pump circuit.
Aspect 20: The method according to any of Aspects 14-19, wherein the first current associated with the first SMPS circuit is a first output current through the output of the first SMPS circuit and wherein the second current associated with the second SMPS circuit is a second output current through the output of the second SMPS circuit. additional considerations

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A power supply circuit comprising:
a common output node;
a first switched-mode power supply (SMPS) circuit including an output coupled to the common output node;
one or more first sensors coupled to the first SMPS circuit;
a second SMPS circuit including an output coupled to the common output node;
one or more second sensors coupled to the second SMPS circuit; and
a control circuit configured to:
receive, from the one or more first sensors, a first indication of a first current or a first temperature associated with the first SMPS circuit;
receive, from the one or more second sensors, a second indication of a second current or a second temperature associated with the second SMPS circuit; and
control, based on the first indication and the second indication, adjustment of an operating frequency of the first SMPS circuit.

2. The power supply circuit of claim 1, wherein to control adjustment of the operating frequency of the first SMPS circuit, the control circuit is configured to control decreasing the operating frequency of the first SMPS circuit when the first current or the first temperature associated with the first SMPS circuit is higher than the second current or the second temperature associated with the second SMPS circuit, respectively, until a difference between the second current or the second temperature and the first current or the first temperature, respectively, is less than a first threshold.

3. The power supply circuit of claim 2, wherein the control circuit is configured to control decreasing the operating frequency of the first SMPS circuit dependent on the first current or the first temperature being higher than a second threshold.

4. The power supply circuit of claim 1, wherein to control adjustment of the operating frequency of the first SMPS circuit, the control circuit is configured to control increasing the operating frequency of the first SMPS circuit when the first current or the first temperature associated with the first SMPS circuit is lower than the second current or the second temperature associated with the second SMPS circuit, respectively, until a difference between the first current or the first temperature and the second current or the second temperature, respectively, is less than a first threshold.

5. The power supply circuit of claim 4, wherein the control circuit is configured to control increasing the operating frequency of the first SMPS circuit dependent on the first current or the first temperature being lower than a second threshold.

6. The power supply circuit of claim 1, wherein the first SMPS circuit comprises a first charge pump circuit and wherein the second SMPS circuit comprises a second charge pump circuit.

7. The power supply circuit of claim 1, wherein the one or more first sensors comprise a first current sensor including a first resistive element coupled between the output of the first SMPS circuit and the common output node and wherein the one or more second sensors comprise a second current sensor including a second resistive element coupled between the output of the second SMPS circuit and the common output node.

8. The power supply circuit of claim 1, wherein the first current associated with the first SMPS circuit is a first output current through the output of the first SMPS circuit and wherein the second current associated with the second SMPS circuit is a second output current through the output of the second SMPS circuit.

9. The power supply circuit of claim 1, wherein the first current associated with the first SMPS circuit is a first input current through an input of the first SMPS circuit and wherein the second current associated with the second SMPS circuit is a second input current through an input of the second SMPS circuit.

10. The power supply circuit of claim 1, wherein the first SMPS circuit is disposed on a first integrated circuit and wherein the second SMPS circuit is disposed on a second integrated circuit different from the first integrated circuit.

11. The power supply circuit of claim 10, wherein the control circuit is disposed on the first integrated circuit.

12. The power supply circuit of claim 1, wherein the control circuit is configured to control adjustment of the operating frequency of the first SMPS circuit incrementally over a period of time.

13. The power supply circuit of claim 1, further comprising:
a third SMPS circuit including an output coupled to the common output node; and
one or more third sensors coupled to the third SMPS circuit, wherein the control circuit is further configured to:
receive, from the one or more third sensors, a third indication of a third current or a third temperature associated with the third SMPS circuit; and
control adjustment of an operating frequency of the third SMPS circuit based on the second indication and the third indication.

14. A method of supplying power, the method comprising:
receiving, from one or more first sensors coupled to a first switched-mode power supply (SMPS) circuit including an output coupled to a common output node, a first indication of a first current or a first temperature associated with the first SMPS circuit;
receiving, from one or more second sensors coupled to a second SMPS circuit including an output coupled to the common output node, a second indication of a second current or a second temperature associated with the second SMPS circuit; and
controlling, based on the first indication and the second indication, adjustment of an operating frequency of the first SMPS circuit.

15. The method of claim 14, wherein controlling the adjustment of the operating frequency comprises decreasing the operating frequency of the first SMPS circuit when the first current or the first temperature associated with the first SMPS circuit is higher than the second current or the second temperature associated with the second SMPS circuit, respectively, until a difference between the second current or the second temperature and the first current or the first temperature, respectively, is less than a first threshold.

16. The method of claim 15, wherein decreasing the operating frequency depends on the first current or the first temperature being higher than a second threshold.

17. The method of claim 14, wherein controlling the adjustment of the operating frequency comprises increasing the operating frequency of the first SMPS circuit when the first current or the first temperature associated with the first SMPS circuit is lower than the second current or the second temperature associated with the second SMPS circuit, respectively, until a difference between the first current or the first temperature and the second current or the second temperature, respectively, is less than a first threshold.

18. The method of claim 17, wherein increasing the operating frequency depends on the first current or the first temperature being lower than a second threshold.

19. The method of claim 14, wherein the first SMPS circuit comprises a first charge pump circuit and wherein the second SMPS circuit comprises a second charge pump circuit.

20. The method of claim 14, wherein the first current associated with the first SMPS circuit is a first output current through the output of the first SMPS circuit and wherein the second current associated with the second SMPS circuit is a second output current through the output of the second SMPS circuit.
